(19) United States
(12) Patent Application Publication
(10) Pub. No.: US 2016/0086070 A1
(43) Pub. Date: Mar. 24, 2016

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Takashi Kikumoto, Kanagawa (JP); Kazuhiro Ohkawa, Kanagawa (JP)

(21) Appl. No.: 14/620,299

(22) Filed: Feb. 12, 2015

(30) Foreign Application Priority Data
Sep. 24, 2014 (JP) 2014-193822

(51) Int. Cl. G06K 15/00; G06K 15/02

(52) U.S. Cl. CPC G06K 15/408; G06K 15/027

(57) ABSTRACT

An image forming apparatus includes a detection unit and a control unit. The detection unit detects an abnormality of imposition printing. The control unit performs in response to the abnormality influencing a finish region in imposition printing in an imposition layout, the imposition printing in another imposition layout in which the abnormality does not influence the finish region.

### CROSS-REFERENCE TO RELATED APPLICATIONS

This application is based on and claims priority under 35 USC 119 from Japanese Patent Application No. 2014-193822 filed on Sep. 24, 2014.

### BACKGROUND

1. Technical Field

The present invention relates to an image forming apparatus and a non-transitory computer readable medium.

2. Related Art

A printing agent receives an order for printed matter from a customer and is required to deliver the printed matter to the customer within the delivery date, and thus it is necessary to perform business with high efficiency by reducing time for which the business stops due to maintenance or exchange of components even in a case where a certain abnormality occurs in a printing apparatus.

### SUMMARY

An aspect of the present invention provides an image forming apparatus including: a detection unit that detects an abnormality of imposition printing; and a control unit that performs in response to the abnormality influencing a finish region in imposition printing in an imposition layout, the imposition printing in another imposition layout in which the abnormality does not influence the finish region.

### BRIEF DESCRIPTION OF THE DRAWINGS

Exemplary embodiment(s) of the present invention will be described in detail based on the following figures, wherein

FIG. 1 is a block diagram illustrating a configuration according to a first embodiment;

FIG. 2 is a process flowchart according to the first embodiment;

FIG. 3 is a diagram illustrating a relationship between a finish region and a poor printing region;

FIG. 4 is a process flowchart according to a second embodiment;

FIG. 5 is a diagram illustrating a parallel movement of a finish region;

FIG. 6 is a diagram illustrating a parallel movement of a finish region;

FIG. 7 is a diagram illustrating a change of a paper feeding direction;

FIG. 8 is a diagram illustrating that the number of imposition pages is reduced;

FIG. 9 is a diagram illustrating that a paper size is enlarged;

FIG. 10 is a diagram illustrating that a paper size is reduced;

FIG. 11 is a diagram illustrating a checking screen;

FIG. 12 is a process flowchart according to a third embodiment;

FIG. 13 is a process flowchart according to a fourth embodiment;

FIG. 14 is a diagram illustrating a checking screen; and

FIG. 15 is a diagram illustrating an imposition layout editing screen.

### DETAILED DESCRIPTION

Hereinafter, exemplary embodiment(s) of the present invention will be described with reference to the drawings.

<Fundamental Principle>

First, a fundamental principle of the present embodiment will be described.

In commercial printing, original input document data is not printed without change, but imposition is performed in consideration of subsequent processing so that output data is created. The imposition is generally performed according to a method in which paper with a size larger than final printed matter which will be delivered to a customer is used, a register mark, a color patch, a color ball, and information regarding other printing jobs are printed on the paper, and the paper is finally cut. Here, the “register mark” refers to marks which are added to vertical and/or horizontal center(s), four corners, and the like in order to register a position for cutting paper to a finish size or multicolor printing when printed matter is created.

In the present embodiment, as mentioned above, focusing on the fact that paper with a size larger than that of final printed matter is used, and a register mark, a color patch, a color ball, and information regarding other printing jobs are printed on the paper in the imposition printing, even if a failure causing poor printing occurs due to an abnormality of an apparatus, as long as a position of the poor printing is located outside a final finish region, that is, the position is located in a region which is not provided to a customer when paper is cut, it is determined that this does not influence quality of a printed image, and thus the printed matter can be provided to the customer, and thus printing work is continuously performed while maintaining the quality of the printed matter. In the present embodiment, an influence on image data to be printed is determined on the basis of a relationship between a position of poor printing and a position in an imposition layout, and in a case where there is no influence, printing work is maintained.

On the other hand, in a case where the position of the poor printing influences a final finish region, quality of image data printed in this state is reduced, and thus printing work is stopped. However, if a relationship between a position of the finish region and the position of the poor printing is relatively changed by changing the imposition layout and thus the influence of the poor printing can be avoided, printing work is continuously performed by using such an imposition layout as a new imposition layout.

Next, an image forming apparatus in the present embodiment will be described in detail by exemplifying a printing apparatus.

### First Embodiment

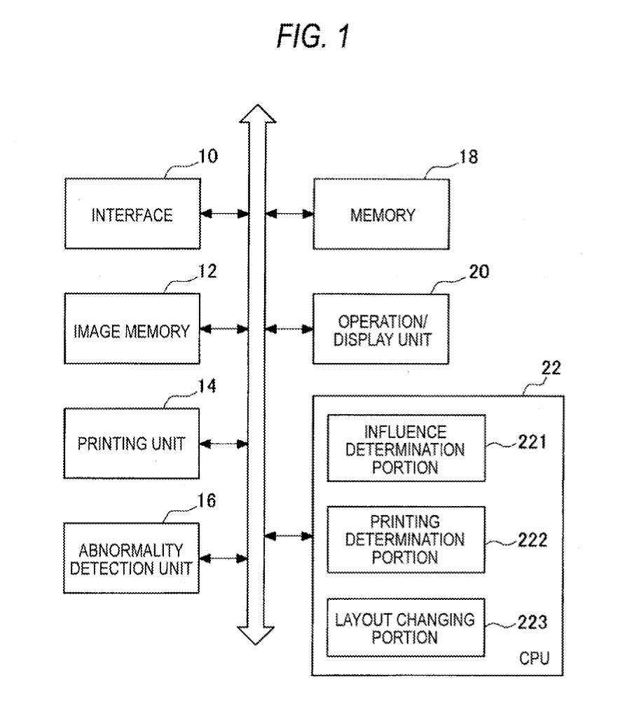

FIG. 1 is a block diagram illustrating a configuration of a printing apparatus according to the present embodiment. The printing apparatus includes an interface 10, an image memory 12, a printing unit 14, an abnormality detection unit 16, a memory 18, an operation/display unit 20, and a CPU 22.

The interface 10 receives image data to be printed from a host computer connected to a network such as the Internet or a LAN.

The image memory 12 stores the image data received from the host computer.

The printing unit 14 prints the image data stored in the image memory 12 on paper. For example, in a case where the printing apparatus is an inkjet printer, the printing unit 14 includes a carriage provided with a plurality of heads which are disposed in a main scanning direction and a head driving circuit, and performs printing by each head ejecting ink droplets of a cartridge with a specific color from nozzles onto paper. The head driving circuit controls an ejection timing of ink droplets in each head on the basis of the image data stored in the image memory 12.

The abnormality detection unit 16 detects abnormalities of the printing unit 14, for example, non-ejection of ink from the nozzles, flaws of a drum, or the like. Any abnormality detection method may be used, and, for example, trial printing of a specific pattern may be performed at certain intervals, and an abnormality may be detected by reading a printing result thereof.

The memory 18 is a program memory or a working memory, and stores a processing program executed by the CPU 22 or temporarily stores data for use in a predetermined calculation function executed by the CPU 22.

The operation/display unit 20 allows a user's various operations to be input, and displays various pieces of information to the user. As an example of information displayed on the operation/display unit 20, there is information for requesting a user to confirm execution of printing by displaying another imposition layout for avoiding a case where poor printing caused by an abnormality of the printing unit 14 influences a finish region of imposition printing. The operation/display unit 20 may be constituted by a touch panel, and may be constituted by an input device such as a keyboard or a mouse and a display device such as a liquid crystal display.

The CPU 22 controls an operation of each unit of the printing apparatus. Particularly, the CPU 22 controls an operation of the printing unit 14, and also controls whether or not a printing job is executed in the printing unit 14 according to a position of poor printing caused by an abnormality in a case where the abnormality is detected by the abnormality detection unit 16. The CPU 22 includes an influence determination portion 221, a printing determination portion 222, and a layout changing portion 223 as functional blocks.

The influence determination portion 221 compares an imposition layout when image data stored in the image memory 12 is printed on paper with a position of poor printing caused by an abnormality detected by the abnormality detection unit 16 and determines whether or not a finish region included in an imposition layout is influenced by the poor printing.

The printing determination portion 222 determines whether or not a printing job is performed in the printing unit 14 on the basis of a determination result in the influence determination portion 221. Specifically, if there is no influence, the printing job is continuously performed even if the poor printing occurs. On the other hand, if there is an influence, the printing job is not performed, or printing is performed in another imposition layout which can avoid the influence.

The layout changing portion 223 changes the present imposition layout and outputs the changed imposition layout to the operation/display unit 20 on the basis of a determination result in the influence determination portion 221. Specifically, if there is an influence, a layout is changed by moving a finish region, and a poor printing position is moved to outside of the finish region. The change of the imposition layout is realized by changing various parameters of a setting file of an imposition layout stored in the memory 18. The various parameters are a position of a finish region, a paper size, a paper feeding direction, and the like. Plural patterns are prepared in advance as templates of an imposition layout and are stored in the memory 18.

Each functional block of the CPU 22 is realized by the CPU 22 reading and sequentially executing processing programs stored in the memory 18. Of course, at least one of the functional blocks may be realized by hardware such as an ASIC.

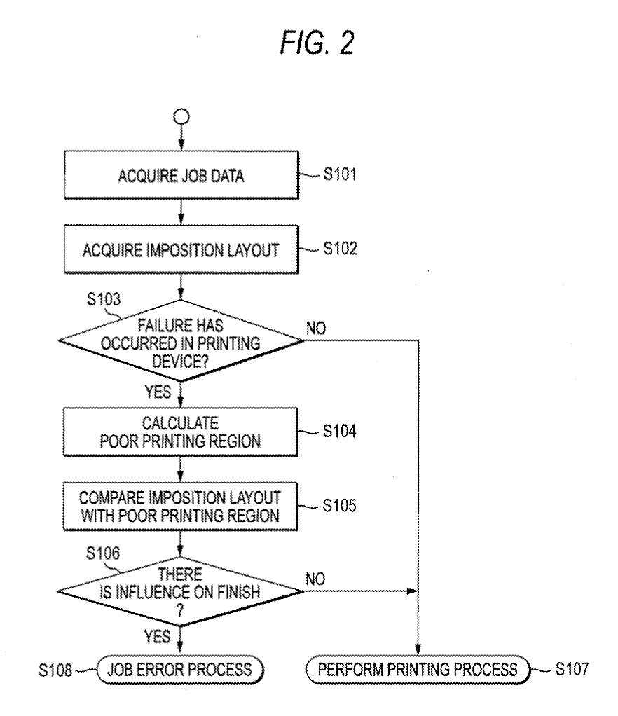

FIG. 2 is a process flowchart, and illustrates an example of a fundamental process.

First, the printing apparatus acquires image data as job data from a host computer (step S101). The image data is stored in the image memory 12.

Next, the CPU 22 acquires, from a setting file, imposition layout data used when the image data is printed (step S102). In the imposition layout, paper with a size larger than that of final printed matter delivered to a customer is used, and a position of final printed matter or a position of a register mark, a color patch, a color ball, or information regarding other printing jobs is determined. The imposition layout data includes position data on regions thereof.

Next, the CPU 22 determines whether or not a failure has occurred in a printing device, that is, the printing unit 14 on the basis of a detection signal from the abnormality detection unit 16 (step S103). If there is no failure in the printing unit 14, a printing job is performed in the printing unit 14 without change (step S107).

On the other hand, if a failure occurs in the printing unit 14 (YES in step S103), the CPU 22 calculates a poor printing region on the basis of a detection signal from the abnormality detection unit 16 (step S104). In addition, the imposition layout acquired in step S102 is compared with the poor printing region calculated in step S104 (step S105), and it is determined whether or not there is an influence on finishing (step S106). In relation to whether or not there is an influence on finishing, specifically, position data of a finish region in the imposition layout is compared with position data of the poor printing region, and, if at least a part of the poor printing region is located in the finish region, it is determined that there is an influence. In addition, if the entire poor printing region is located outside the finish region, it is determined that there is no influence. It should be noted that there may be a case where it is determined that there is no influence on a relative positional relationship with the finish region even if the poor printing region is present.

If there is no influence on finishing (NO in step S106), a printing job is performed without change even if a failure occurs in the printing unit 14 (step S107). If there is an influence on finishing (YES in step S106), an error process of the printing job is performed (step S108). The error process of the printing job is, for example, non-execution of the printing job. In this case, an error message (“the printing job is stopped due to poor printing”) is displayed on the operation/display unit 20. In addition, the error process of the printing job also includes a change of an imposition layout which will be described later.

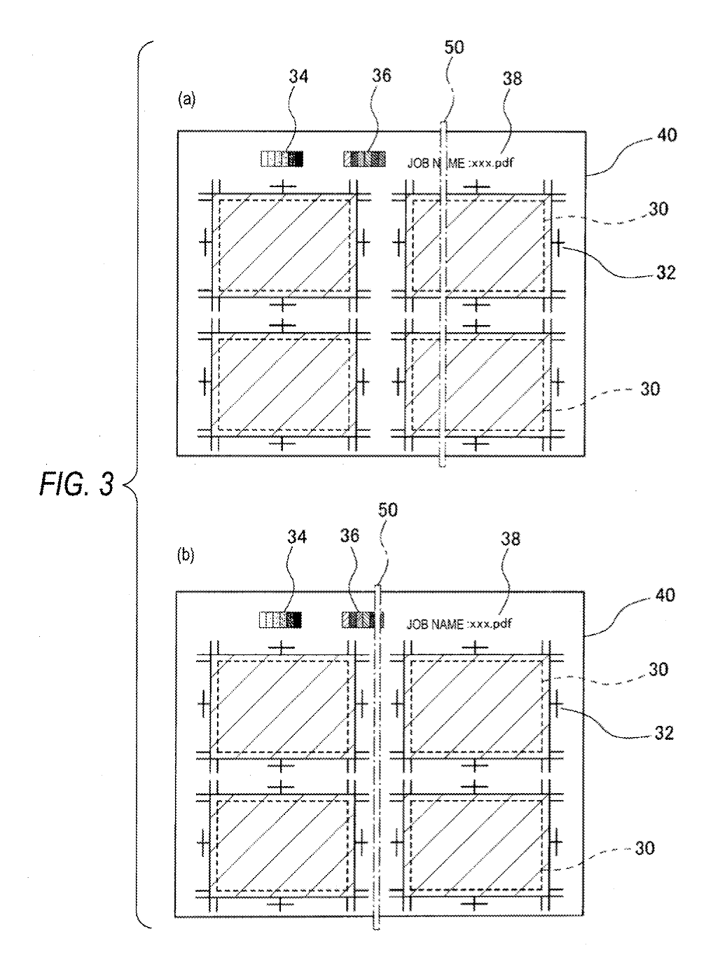

FIG. 3 schematically illustrates the process in step St 105 of FIG. 2, that is, the comparison process of the imposition layout and the poor printing region. In FIG. 3, a region 30 indicated by a dashed line is a finish region after cutting paper, and is an image data region which is finally delivered to a customer. Register marks 32 are formed around the finish region 30, and a color patch 34, a color ball 36, and a job name 38 as information regarding a printing job are printed at a predetermined position on paper 40, for example, a blank region of an upper end of the paper 40. In addition, a printing job name is transmitted from the host computer along with image data.

(a) of FIG. 3 illustrates a case where a region 50 which becomes void due to non-ejection of ink from the nozzles overlaps the finish region 30, as a failure caused by an abnormality of the printing unit 14. If the poor printing region (void region) 50 overlaps the finish region 30 as mentioned above, there is an influence on finishing. The CPU 22 compares position data of the imposition layout with position data of the poor printing region, and determines that there is an influence on finishing so as to perform an error process in a case where position data of the finish region 30 in the position data of the imposition layout overlaps the position data of the poor printing region in at least parts thereof.

(b) of FIG. 3 illustrates a case where the poor printing region (void region) 50 as a failure caused by the abnormality of the printing unit 14 does not overlap the finish region 30. This case is a case where the void region 50 is located between the finish regions 30. In this case, even if there is the void region 50, this does not influence finishing. The CPU 22 compares position data of the imposition layout with position data of the poor printing region 50, and determines that there is no influence on finishing so as to perform a printing job in a case where position data of the finish region 30 in the position data of the imposition layout does not overlap the position data of the poor printing region 50.

In the present embodiment, imposition layout information includes a size of paper which is used, an arrangement position of a finish region, the presence or absence of setting and arrangement positions of a register mark, a color patch, and a color ball, and the presence or absence of setting and an arrangement position of job information, but there may be a case where paper cannot be cut at an accurate position since poor printing occurs at an arrangement position of a register mark even if there is no influence on a finish region. Therefore, when it is determined whether or not there is an influence on finishing in steps S105 and S106 of FIG. 2, position data of the finish region 30 may not only be compared with position data of the poor printing region 50, but may also be compared with the position data of the poor printing region 50 for each element of the imposition layout. For example, position data of the finish region 30 is compared with position data of the poor printing region 50, and position data of a register mark is also compared with the position data of the poor printing region 50, so that it is determined that there is no influence on finishing in a case where the poor printing region 50 does not overlap any element. Alternatively, there may be a configuration in which a user can select which elements of the imposition layout is compared with a poor printing region. For example, a finish region, a bleed width, and a register mark are set as comparison targets, and a color patch, a color ball, job information, and section mark/collating mark are not set as comparison targets.

### Second Embodiment

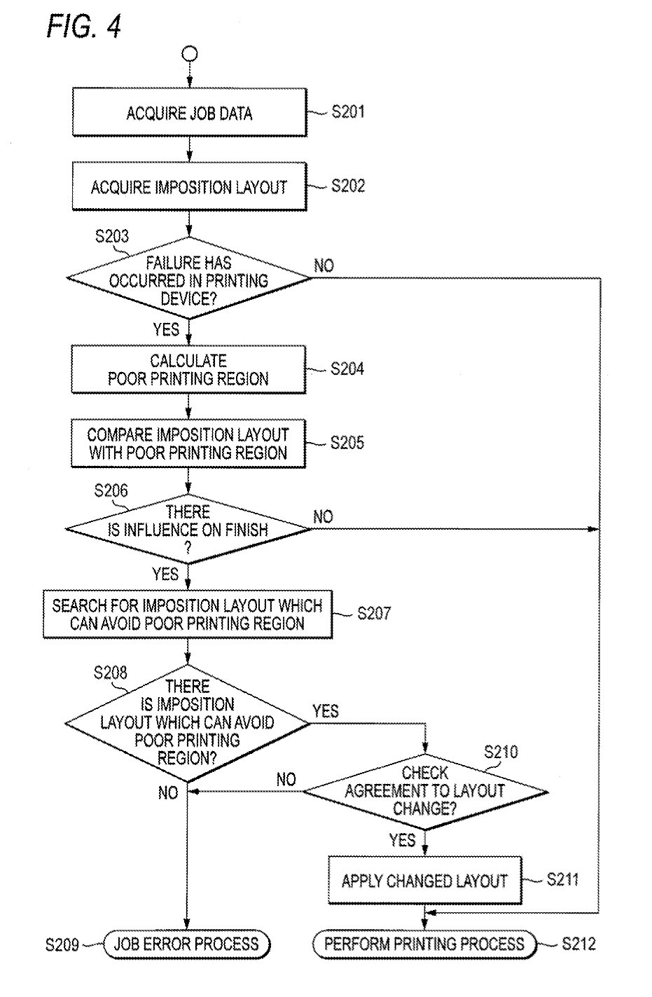

FIG. 4 is a process flowchart of the present embodiment. This example is an example in which a printing job is performed in another imposition layout which can avoid an influence in a case where poor printing has an influence on a finish region.

First, the printing apparatus acquires image data as job data from the host computer (step S201). The image data is stored in the image memory 12.

Next, the CPU 22 acquires imposition layout data from a setting file (step S202).

Next, the CPU 22 determines whether or not a failure has occurred in a printing device, that is, the printing unit 14 on the basis of a detection signal from the abnormality detection unit 16 (step S203). If there is no failure in the printing unit 14, a printing job is performed in the printing unit 14 without change (step S212).

On the other hand, if a failure occurs in the printing unit 14 (YES in step S203), the CPU 22 calculates a poor printing region on the basis of a detection signal from the abnormality detection unit 16 (step S204). In addition, the imposition layout acquired in step S202 is compared with the poor printing region calculated in step S204 (step S205), and it is determined whether or not there is an influence on finishing (step S206). If there is no influence on finishing (NO in step S206), the printing job is performed without change (step S212) even if a failure occurs in the printing unit 14.

If there is an influence on finishing (YES in step S206), the layout changing portion 223 of the CPU 22 searches for another imposition layout which can avoid the poor printing region (step S207). Specifically, the imposition layout is changed by changing various parameters in a layout template stored in the memory 18 or changing the layout template, and position data of the finish region in the changed imposition layout is compared with position data of the poor printing region so that it is determined whether or not both of the position data items overlap each other. In a case where different paper sizes are used in different templates, it is noted that a paper size is changed by changing a template, and thus a relative positional relationship between a finish region and a poor printing region may be changed. If both of the position data items do not overlap each other, another imposition layout is determined as being capable of avoiding a poor printing region, and if both of the position data items overlap each other, another imposition layout is not determined as being capable of avoiding a poor printing region. In addition to position data of a finish region, position data of a register mark may be used as a comparison target as described above.

If there is no imposition layout which can avoid a poor printing region (NO in step S208), an error process of the printing job is performed (step S209). Specifically, the printing job is stopped, and an error message is displayed on the operation/display unit 20. In addition, if there is an imposition layout which can avoid a poor printing region (YES in step S208), the CPU 22 displays the presence of the imposition layout on the operation/display unit 20 and notifies a user of checking of a layout change. If the user agrees to the layout change (YES in step S210), the CPU 22 applies the changed imposition layout so as to perform the printing job (steps S211 and S212). If the user does not agree to the layout change (NO in step S210), an error process of the printing job is performed (step S209).

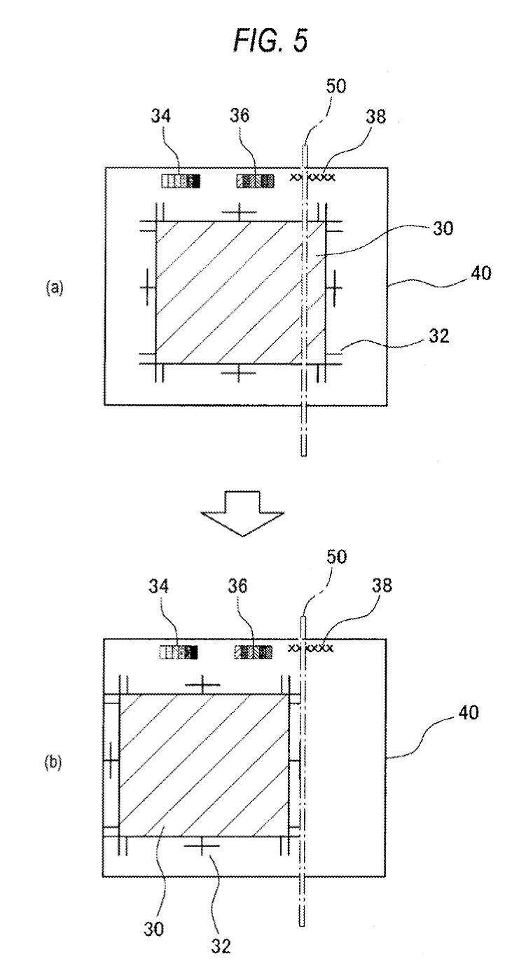

FIG. 5 illustrates an example of an imposition layout which can avoid a poor printing region. In a case where the finish region 30 overlaps the poor printing region 50 as illustrated in (a) of FIG. 5, all finish regions 30 are moved in parallel so that the finish region 30 does not overlap the poor printing region 50 as illustrated in (b) of FIG. 5. Of course, not only the finish region 30 but also the register marks 32 may be moved in parallel so as not to overlap the poor printing region 50.

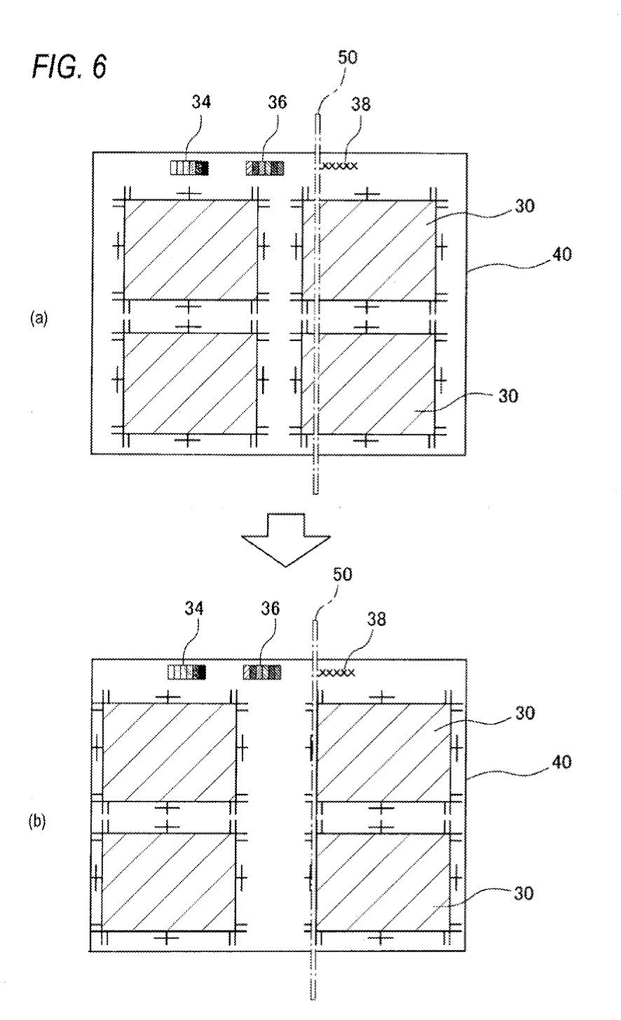

FIG. 6 illustrates another example of an imposition layout which can avoid a poor printing region. In a case where the finish region 30 overlaps the poor printing region 50 as illustrated in (a) of FIG. 6, the finish regions 30 are moved in parallel so that the poor printing region 50 is located between plural finish regions 30 as illustrated in (b) of FIG. 6.

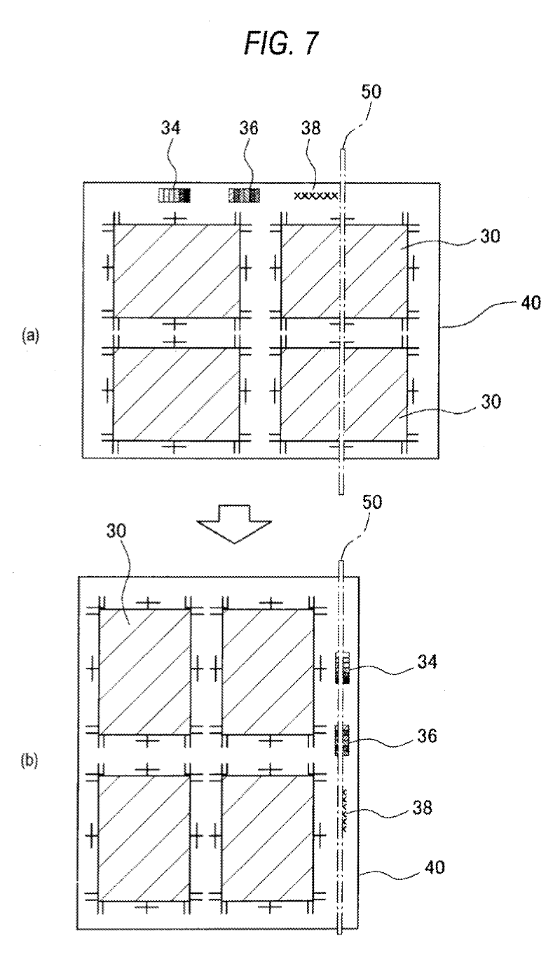

FIG. 7 illustrates still another example of an imposition layout which can avoid a poor printing region. In a case where the finish region 30 overlaps the poor printing region 50 as illustrated in (a) of FIG. 7, a paper feeding direction is changed by 90 degrees so that the finish region 30 does not overlap the poor printing region 50 as illustrated in (b) of FIG. 7.

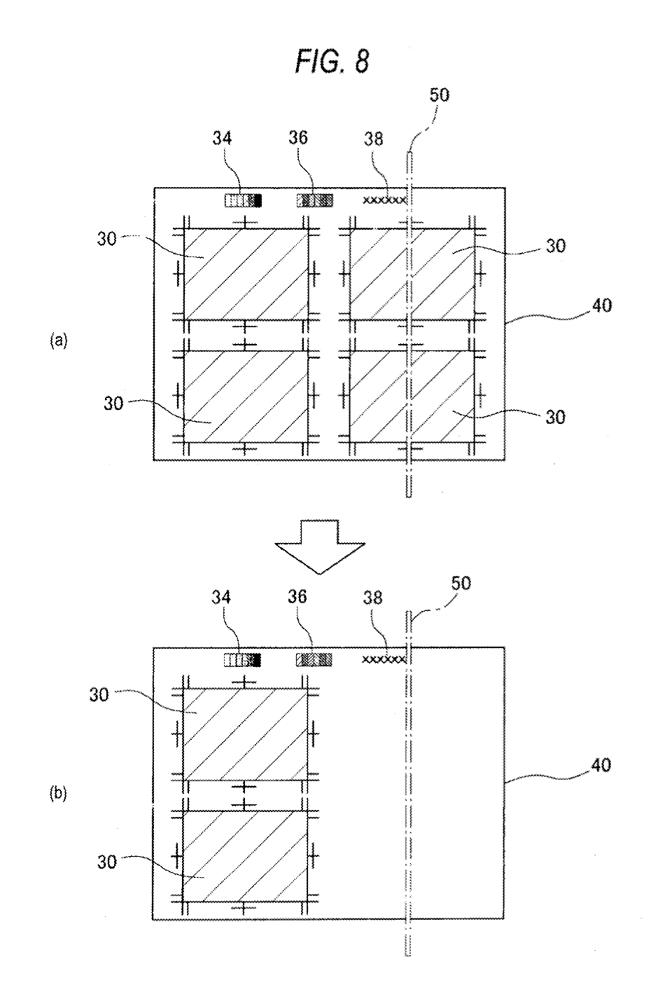

FIG. 8 illustrates still another example of an imposition layout which can avoid a poor printing region. In a case where, among plural finish regions 30, some of the finish regions 30 overlap the poor printing region 50 as illustrated in (a) of FIG. 8, regions which overlap the poor printing region 50 are removed among the finish regions 30, that is, the number of imposition pages is reduced so that the finish region 30 does not overlap the poor printing region 50 as illustrated in (b) of FIG. 8.

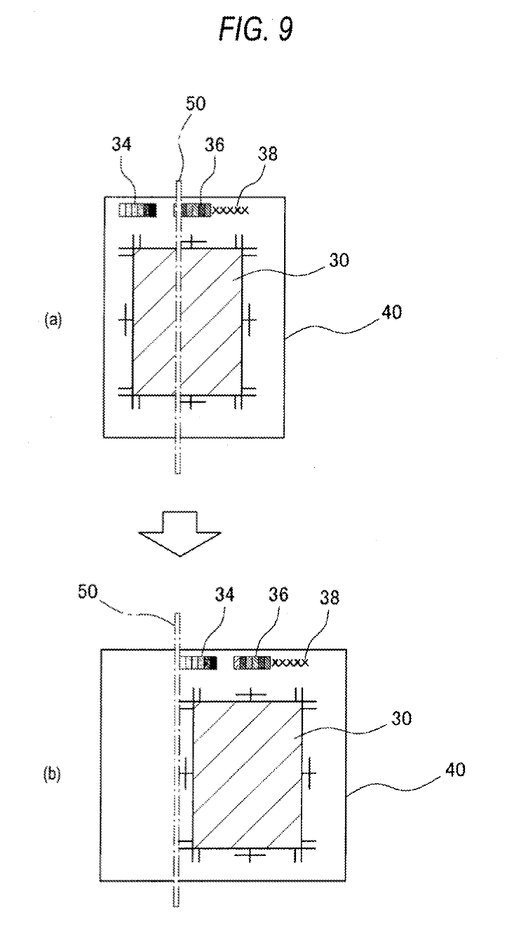

FIG. 9 illustrates still another example of an imposition layout which can avoid a poor printing region. In a case where the finish region 30 overlaps the poor printing region 50 as illustrated in (a) of FIG. 9, a size of the paper 40 is enlarged so that the finish region 30 does not overlap the poor printing region 50 as illustrated in (b) of FIG. 9.

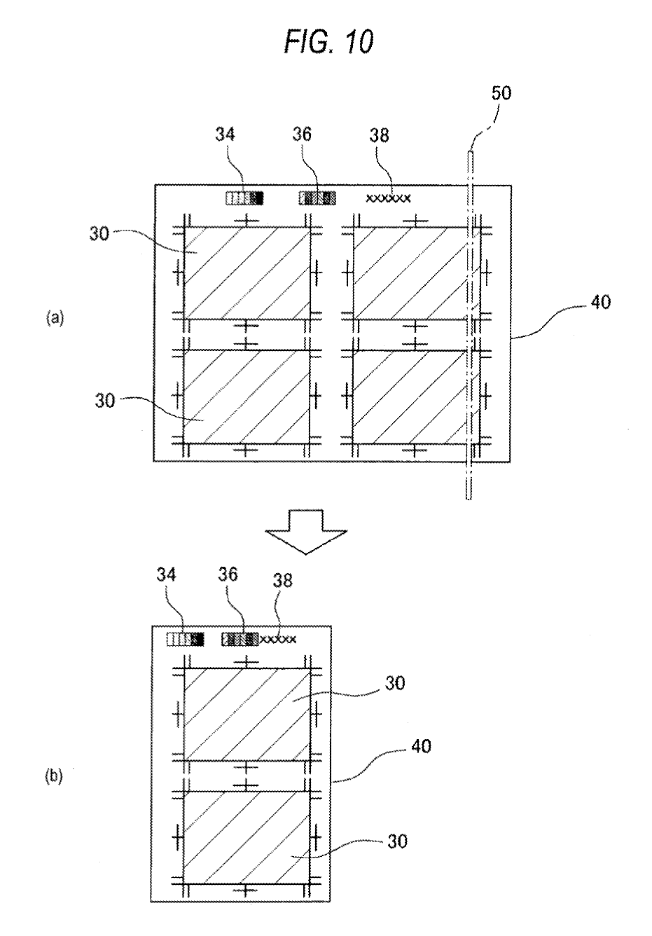

FIG. 10 illustrates still another example of an imposition layout which can avoid a poor printing region. In a case where some of plural finish regions 30 overlap the poor printing region 50 as illustrated in (a) of FIG. 10, a size of the paper 40 is reduced so that the finish region 30 does not overlap the poor printing regions 50 as illustrated in (b) of FIG. 10.

As mentioned above, layout changes such as a parallel movement of a finish region, a change of a paper feeding direction, a reduction of the number of imposition pages, and enlargement or reduction of a paper size are performed alone or in combination thereof (a combination of FIGS. 5 and 7, or a combination of FIGS. 5 and 9), so that it is possible to avoid overlapping between a finish region and a poor printing region and thus to remove an influence of the poor printing region.

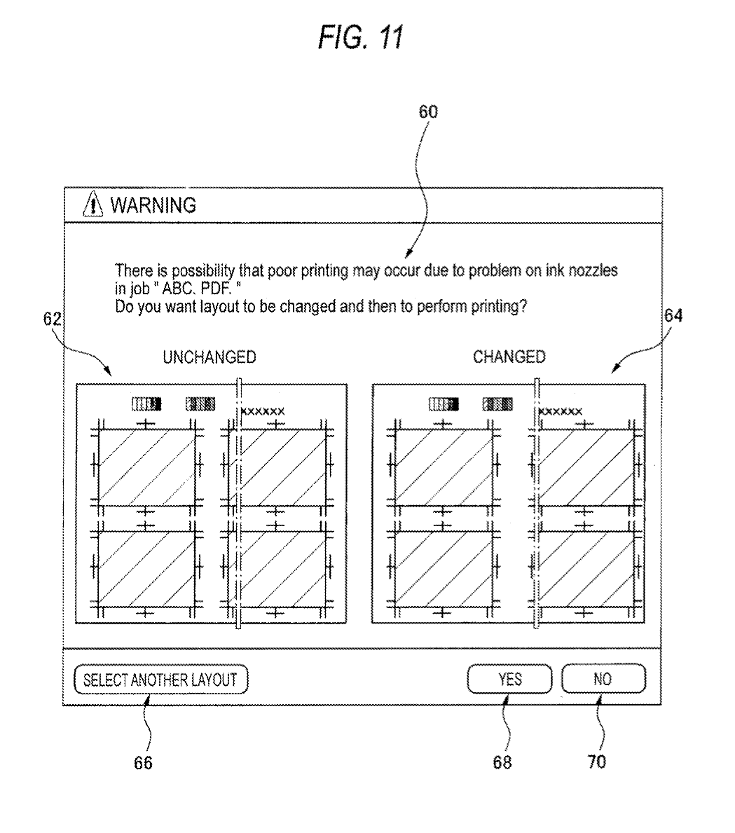

FIG. 11 illustrates a display example of the process in step S210 of FIG. 4 in which, in a case where another layout which can avoid a poor printing region is present, the presence thereof is displayed on the operation/display unit 20 and the user is requested to perform checking. A message 60, “There is a possibility that poor printing may occur due to a problem of the ink nozzles in the job ABC.PDF. Do you want the layout to be changed and then to perform printing?”, is displayed at a position on a screen. An aspect (a problem of the ink nozzles) of an abnormality in the printing unit 14 is also displayed in this message, but only a possibility that poor printing may occur may be displayed. In addition, along with this message 60, the unchanged, that is, present imposition layout 62 and a changed imposition layout 64 which can avoid a poor printing region are displayed in parallel to each other so as to be compared with each other. In this case, a poor printing location or a poor printing region is preferably displayed as well. This is because the user may compare both the layouts with each other and can thus easily understand how an imposition layout is changed and therefore how an influence on printed image data is avoided. In addition, a button 66 for “another layout selection” is displayed at a position (the lower left part in the figure) of the screen, and this button is selected in a case where the user is not satisfied with the changed imposition layout 64 which is displayed. In a case where this button 66 is operated, the layout changing portion 223 of the CPU 22 searches for a layout other than the imposition layout 64 again and displays the layout on the screen. In a case where the user is satisfied with the changed imposition layout 64, a “Yes” button 68 displayed at a position (the lower right part in the figure) of the screen is operated. On the other hand, in a case where the user is not satisfied, a “No” button 70 is operated. When the “No” button 70 is operated, the CPU 22 performs an error process (step S209).

As mentioned above, in the present embodiment, even in a case where poor printing has an influence on a finish region, printing work can be continuously performed in another imposition layout which can avoid the influence while maintaining quality of final printed matter.

### Third Embodiment

In the first and second embodiments, a description has been made of a case where an abnormality of the printing unit 14 is detected in advance before performing a printing job, but, in the present embodiment, a description will be made of a case where an abnormality occurs in the printing unit 14 during execution of the printing job.

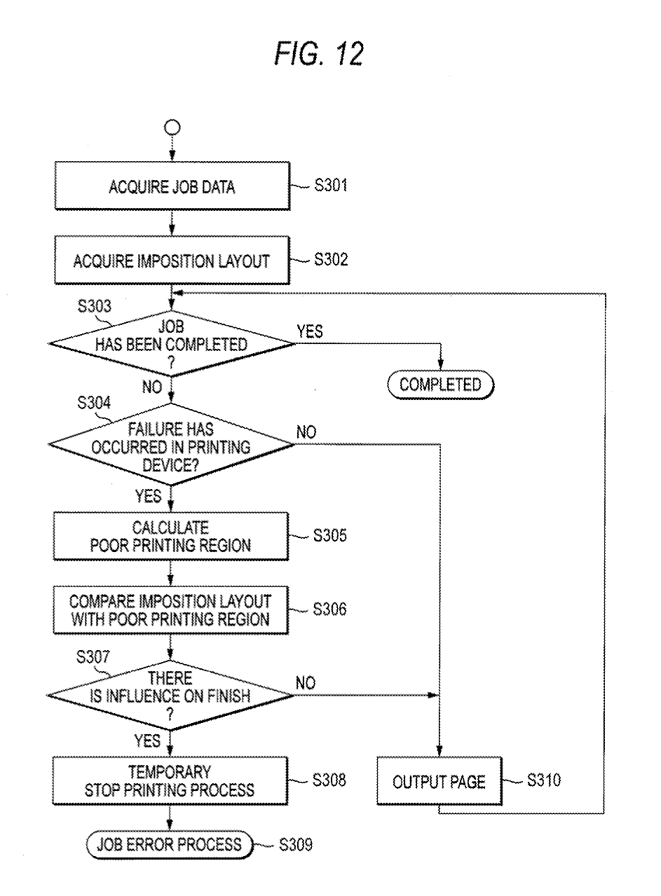

FIG. 12 is a process flowchart of the present embodiment.

First, the printing apparatus acquires image data as job data from the host computer (step S301). The image data is stored in the image memory 12.

Next, the CPU 22 acquires imposition layout data from a setting file (step S302).

Next, the CPU 22 determines whether or not a printing job has been completed (step S303). If the printing process has been completed, there is no problem, and thus the process is finished as it is.

On the other hand, if the printing job has not been completed (NO in step S303), the CPU 22 determines whether or not a failure has occurred in the printing device, that is, the printing unit 14 on the basis of a detection signal from the abnormality detection unit 16 (step S304). If there is no failure in the printing unit 14, a printing job is performed in the printing unit 14 without change, and then a page is output (step S310).

On the other hand, if a failure occurs in the printing unit 14 (YES in step S304), the CPU 22 calculates a poor printing region on the basis of a detection signal from the abnormality detection unit 16 (step S305). In addition, the imposition layout acquired in step S302 is compared with the poor printing region calculated in step S305 (step S306), and it is determined whether or not there is an influence on finishing (step S307). If there is no influence on finishing (NO in step S307), a printed page is output without change (step S310) even if a failure occurs in the printing unit 14. If there is an influence on finishing (YES in step S307), the CPU 22 temporarily stops the printing process (step S308), and performs an error process (step S309). For example, the error process may be displaying an error message on the operation/display unit 20.

In the present embodiment, the reason why a printing process is instantly temporarily stopped without searching for another layout which can avoid an influence if there is the influence on finishing (YES in step S307) is that it not preferable to change an imposition layout to another layout during execution of a printing job. Therefore, in a case where there are special circumstances in which there is no influence on a final product even if an imposition layout is changed during execution of a printing job, another layout which can avoid a poor printing region may be searched for. This embodiment will be described next.

### Fourth Embodiment

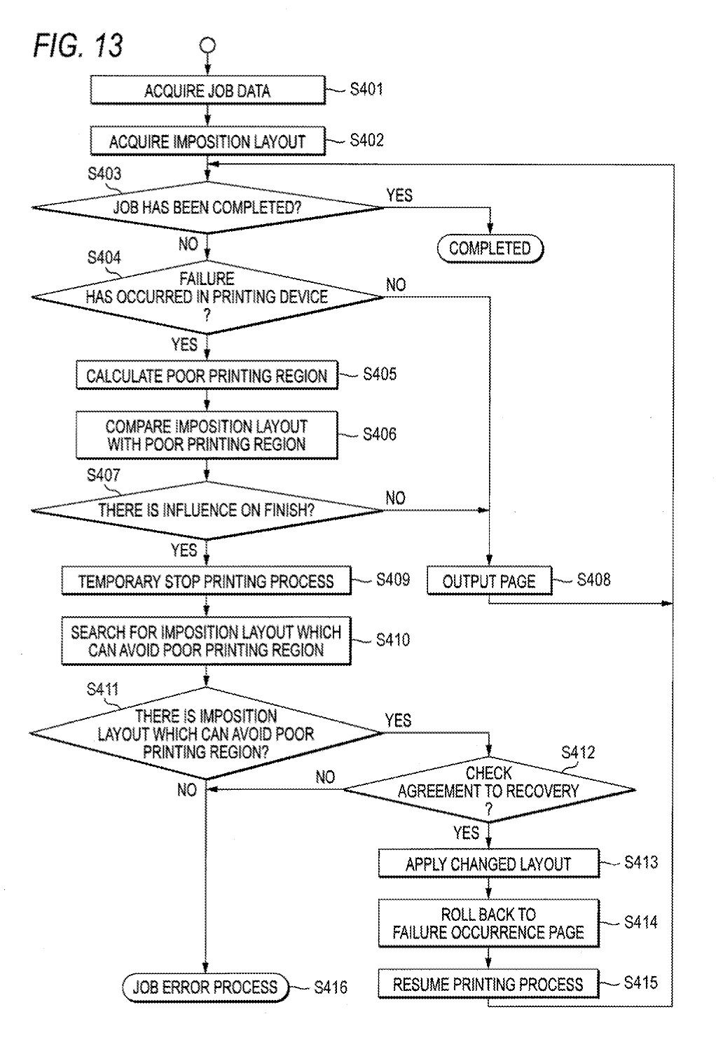

FIG. 13 is a process flowchart of the present embodiment. This case is a case where an abnormality occurs during execution of a printing job in the same manner as in the third embodiment.

First, the printing apparatus acquires image data as job data from the host computer (step S401). The image data is stored in the image memory 12.

Next, the CPU 22 acquires imposition layout data from a setting file (step S402).

Next, the CPU 22 determines whether or not a printing job has been completed (step S403). If the printing process has been completed, there is no problem, and thus the process is finished as it is.

On the other hand, if the printing job has not been completed (NO in step S403), the CPU 22 determines whether or not a failure has occurred in the printing device, that is, the printing unit 14 on the basis of a detection signal from the abnormality detection unit 16 (step S404). If there is no failure in the printing unit 14, a printing job is performed in the printing unit 14 without change, and then a page is output (step S408).

On the other hand, if a failure occurs in the printing unit 14 (YES in step S404), the CPU 22 calculates a poor printing region on the basis of a detection signal from the abnormality detection unit 16 (step S405). In addition, the imposition layout acquired in step S402 is compared with the poor printing region calculated in step S405 (step S406), and it is determined whether or not there is an influence on finishing (step S407). If there is no influence on finishing (NO in step S407), a printed page is output without change (step S408) even if a failure occurs in the printing unit 14. If there is an influence on finishing (YES in step S407), the printing process is temporarily stopped (step S409), and the CPU 22 searches for another imposition layout which can avoid a poor printing region (step S410).

If there is no imposition layout which can avoid a poor printing region (NO in step S411), an error process of the printing job is performed (step S416). In addition, if there is an imposition layout which can avoid a poor printing region (YES in step S411), the user is notified of another layout and is requested to check the layout (step S412). If the user does not agree to a layout change, an error process of the printing job is performed (step S416), and if the user agrees to the layout change, the changed layout is applied (step S413) so that a page is rolled back to a page in which a failure has occurred (step S414), and the printing process is resumed (step S415). In other words, in a case where a failure occurrence page is a P-th page, printing is performed from the P-th page again back to the P-th page in which the failure has occurred, in the changed imposition layout.

In addition, in a case where an imposition layout from a middle page cannot be changed due to a printing job, printing may be resumed back to a first page of the printing job. However, since it takes time to resume printing back to the first page, execution or non-execution may be determined by providing a threshold value, for example, such as resuming printing only in a case where a half or less of all steps of the printing job are left.

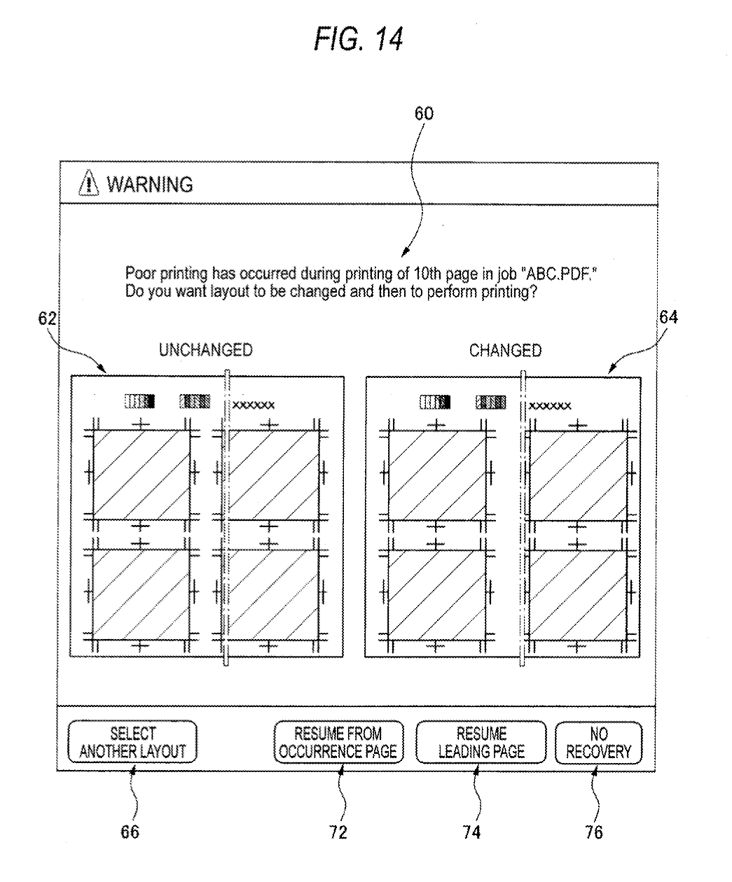

FIG. 14 illustrates a display example of the process in step S412 of FIG. 13 in which, in a case where another layout which can avoid a poor printing region is present, the presence thereof is displayed on the operation/display unit 20 and the user is requested to agree. Along with display of the message 60 indicating that poor printing has occurred during printing, an unchanged (present) imposition layout 62 and a changed imposition layout 64 which can avoid a poor printing region are displayed. In addition, the button 66 for selecting another layout is displayed at a position.

On the other hand, unlike in the case of FIG. 11, a button 72 for resumption from a failure occurrence page, a button 74 for resumption from a job head, and a button 76 for non-recovery are newly displayed at positions on the screen. The user selects and operates any one of the buttons 72, 74 and 76 so as to select any one of recovery through resumption from a failure occurrence page, recovery through resumption from a job head, and stopping of printing without recovery.

### Fifth Embodiment

In the first and second embodiment, in a case where a poor printing region has an influence, another layout which can avoid the poor printing region is searched for, and, in this case, a function in which the user can freely edit a desired imposition layout while taking the poor printing region into consideration may be added to the printing apparatus of FIG. 1.

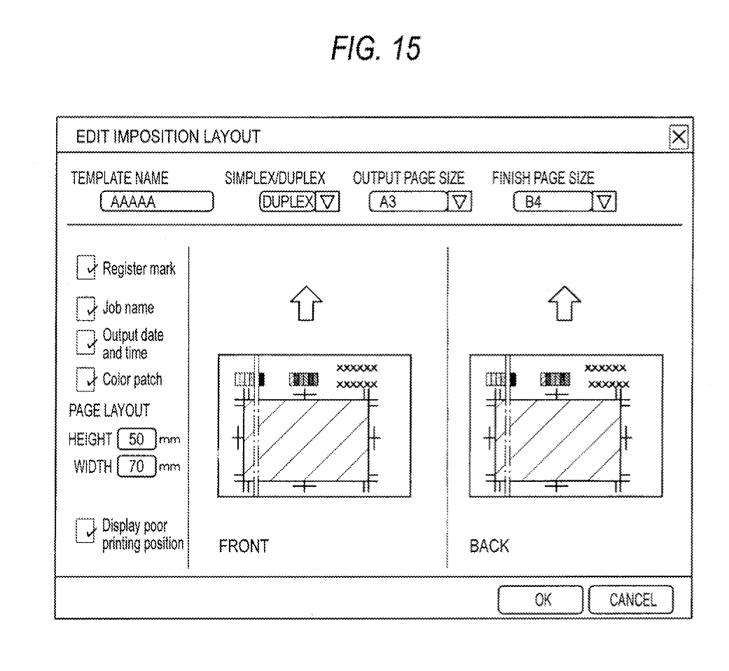

FIG. 15 illustrates an example of an imposition layout editing screen. If it is determined that there is an influence on finishing, for example, in step S206 of FIG. 4, the CPU 22 displays the screen on the operation/display unit 20 so that the user can edit an imposition layout.

In FIG. 15, the poor printing region calculated in step S204 of FIG. 4 is displayed so as to overlap the present imposition layout. In the figure, “front” and “back” are displayed, but either one thereof may be displayed. In addition, an output page size and a finish page size are displayed on the screen, and can be changed as appropriate. Further, display or non-display of a register mark, a job name, the output date and time, and a color patch can be selected in a check box form on the screen, and display or non-display of a poor printing position can also be selected in a check box form on the screen. A poor printing position is not displayed on a typical editing screen, but, in the present embodiment, a check mark is put into the check box, and thus a poor printing position is displayed so as to overlap the imposition layout. Therefore, the user can easily visually recognize to what extent finishing is influenced, and can edit another imposition layout which can avoid a poor printing region on the basis thereof.

As mentioned above, the embodiments of the present invention have been described, but the present invention is not limited to the embodiments and may be variously modified.

For example, in the present embodiment, another imposition layout which can avoid a poor printing region is searched for and is displayed on the operation/display unit 20 so that the user is notified of the imposition layout, but, in this case, the user may be preferentially notified of an imposition layout with a least change amount from an unchanged (present) imposition layout.

In addition, in a case where there are plural printing jobs, when there are no other imposition layouts which can avoid a poor printing region in the present printing job but there are other imposition layouts which can avoid the poor printing region in subsequent printing jobs, the printing job may be preferentially performed.

Further, in the present embodiment, in a case where a position of a poor printing region influences a finish region, another imposition layout which can avoid the poor printing region is searched for and is displayed on the operation/display unit 20 so that the user is requested to check the layout, but a printing job may be automatically performed in another imposition layout without requesting the user to perform checking. However, also in this case, preferably, information indicating that an imposition layout is changed and a printing job is performed is displayed on the operation/display unit 20 at any timing, for example, at the time at which a printing job has been completed.

In addition, in FIG. 15, a poor printing position is displayed along with an imposition layout. However, there may be a configuration in which a poor printing position is not initially displayed, the user decides on an imposition layout and operates an “OK” button, then the CPU 22 compares the poor printing position with the imposition layout, and, only in a case where there is an influence on a finish region, the CPU 22 displays the fact and displays the poor printing position along with the imposition layout.

Further, in the present embodiment, the printing apparatus illustrated in FIG. 1 may be constituted not only by a single apparatus but also by a printing server computer and a printer. In this case, the printing unit 14 is provided in the printer, and the remaining CPU 22, memory 18 and operation/display unit 20, and the like are provided in the printing server computer. A sensor body detecting an abnormality may be provided in the printer, and, also in this case, an input unit of an abnormality detection signal may function as the abnormality detection unit 16 in the printing server computer so that a signal detected by the sensor is input to the printing server computer and thus it is determined whether or not there is an influence or another imposition layout which can avoid a poor printing region is searched for.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a detection unit that detects an abnormality of imposition printing; and
a control unit that performs in response to the abnormality influencing a finish region in imposition printing in an imposition layout, the imposition printing in another imposition layout in which the abnormality does not influence the finish region, the imposition layout defining positions and directions of imposition pages of image data relative to paper.

2. The image forming apparatus according to claim 1, further comprising:
a display unit that displays a screen for checking whether or not the imposition printing is performed in said another imposition layout in which the abnormality does not influence the finish region.

3. The image farming apparatus according to claim 1, wherein said another imposition layout in which the abnormality does not influence the finish region is obtained through at least one of a movement of the finish region, a change of a paper feeding direction, a reduction of the number of imposition pages, and a change of a paper size in the imposition printing.

4. The image forming apparatus according to claim 1, further comprising:
a editing unit that allows an imposition layout to be edited by displaying a positional relationship between the finish region in the imposition printing and a poor printing region caused by the abnormality.

5. The image forming apparatus according to claim 1, wherein, in response to the detection unit detecting the abnormality in the middle of the imposition printing, and the abnormality influencing the finish region in the imposition printing, the control unit stops the imposition printing, and resumes the imposition printing from a page in which the abnormality has occurred or from an initial page in the imposition printing, in said another imposition layout in which the abnormality does not influence the finish region.

6. A non-transitory computer readable medium storing a program causing a computer to execute a process for image forming, the process comprising:
detecting an abnormality of imposition printing; and
performing in response to abnormality influencing a finish region in imposition printing in imposition layout, the imposition printing in another imposition layout in which the abnormality does not influence the finish region, the imposition layout defining positions and directions of imposition pages of image data relative to paper.
